(19) United States
(12) Patent Application Publication
(10) Pub. No.: US 2018/0036889 A1
(43) Pub. Date: Feb. 8, 2018

(54) Dish Manipulation Systems And Methods

(71) Applicant: Dishcraft Robotics, Inc., San Carlos, CA (US)

(72) Inventors: Paul M. Birkmeyer, Redwood City, CA (US); Linda H. Pouliot, San Mateo, CA (US); Kenneth M. Peters, San Mateo, CA (US)

(21) Appl. No.: 15/665,260

(22) Filed: Jul. 31, 2017

Related U.S. Application Data
(60) Provisional application No. 62/372,177, filed on Aug. 8, 2016.

(51) Int. Cl. B25J 11/00; B25J 9/16; A47L 15/42

(52) U.S. Cl. CPC B25J 11/0085; A47L 15/4293; B25J 9/1697; A47L 15/4295; A47L 2401/04

(57) ABSTRACT

Example dish manipulation systems and methods are described. In one implementation, a robotic actuator includes at least one magnet. The robotic actuator is configured to manipulate, using magnetic attraction, an article of magnetic dishware. A processing system electrically coupled to the robotic actuator is configured to generate commands for positioning the robotic actuator in three-dimensional space.

### RELATED APPLICATION

This application claims the priority benefit of U.S. Provisional Application Ser. No. 62/372,177, entitled “Robotic Dishwashing System Using Magnetic Dishware,” filed on Aug. 8, 2016, the disclosure of which is hereby incorporated by reference herein in its entirety.

### TECHNICAL FIELD

The present disclosure relates to systems and methods that use robots to manipulate dishes.

### BACKGROUND

Commercial dishwashing requires the loading of large volumes of soiled dishware into dishwashing machines in order to be cleaned. For personnel employed to accomplish this task, the associated labor is time-consuming, repetitive and monotonous. The process of automating loading soiled dishware into dishwashing machines involves the need to manipulate the soiled dishware, which may include having to move the dishware from a first location to a second location. Manipulating dishware may also be required in cases other than dishwashing; for example, stacking clean dishes. There exists a need, therefore, for an automated method of manipulating dishware that can perform tasks such as loading soiled dishware into dishwashing machines.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1A is a schematic depicting an embodiment of a robotic system configured to manipulate magnetic dishware.

FIG. 1B depicts an embodiment of a processing system that may be used to implement certain functions of a robotic system configured to manipulate magnetic dishware.

FIG. 1C is a block diagram depicting an embodiment of an imaging system coupled to a computer vision module.

FIG. 1D is a block diagram depicting an embodiment of a subsystem including a robotic actuator and a processing system.

FIG. 2 is a schematic diagram depicting an embodiment of an article of magnetic dishware.

FIGS. 3A and 3B are schematic diagrams, each depicting an example article of magnetic dishware.

FIG. 4 is a flow diagram depicting an embodiment of method to manipulate an article of magnetic dishware by a robotic system.

FIGS. 5A and 5B are flow diagrams depicting an embodiment of a method to sort cooking tools using a robotic system.

FIG. 6 is a flow diagram depicting an embodiment of a method to manipulate an article of magnetic dishware by a robotic system.

FIG. 7 is a flow diagram depicting an embodiment of a method that uses a computer vision system to identify an approximate location of an article of dishware.

FIG. 8A is a schematic diagram depicting an embodiment of a magnetic end effector.

FIG. 8B is a schematic diagram depicting an operating mode of a magnetic end effector.

### DETAILED DESCRIPTION

In the following description, reference is made to the accompanying drawings that form a part thereof, and in which is shown by way of illustration specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which includes one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

The systems and methods described herein disclose an apparatus and methods that use a robotic system configured to manipulate magnetic dishware, where the robotic system may include a robot or robotic actuator, a processing system, a computer vision system, and a magnetic end effector that, working in tandem with a set of magnetic dishware, can load dishes into a rack or onto a conveyor in order to automate the dishwashing process. The present disclosure adapts robotic manipulation to automate, for example, the labor of loading dishes (or dishware) into a dishwashing machine. Automating the process of loading dishes into a dishwashing machine includes using a computer vision system to identify the type of dishware and the pose (physical orientation) of the dishware, and then using a magnetic robotic end effector to obtain a grasp of the dishware. The grasped dishware is then moved to a rack (or other structure), and a combination of the computer vision system and magnetic robotic end effector is used to release the grasped dishware into the rack.

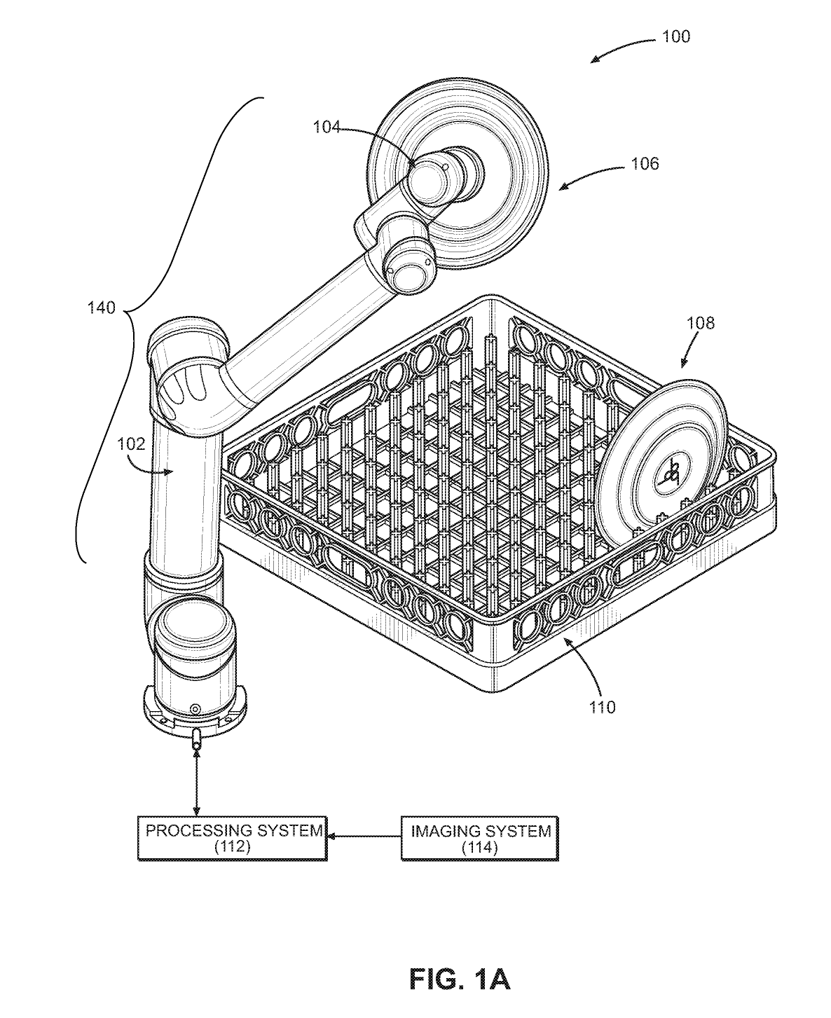

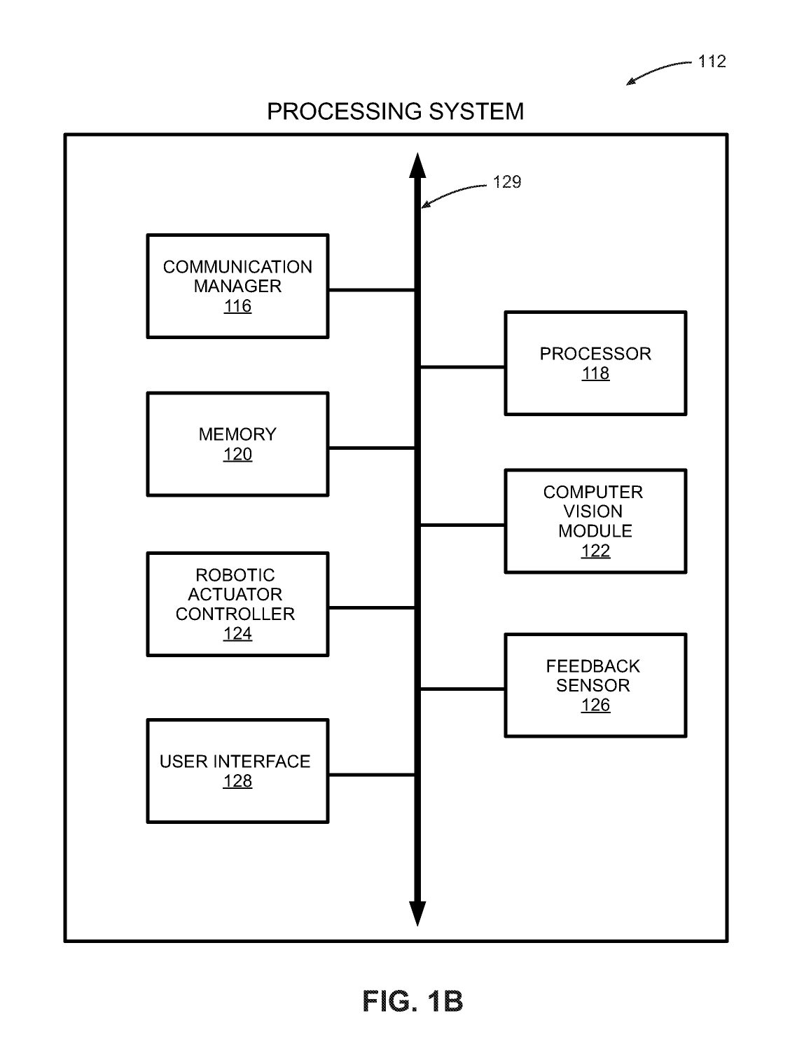

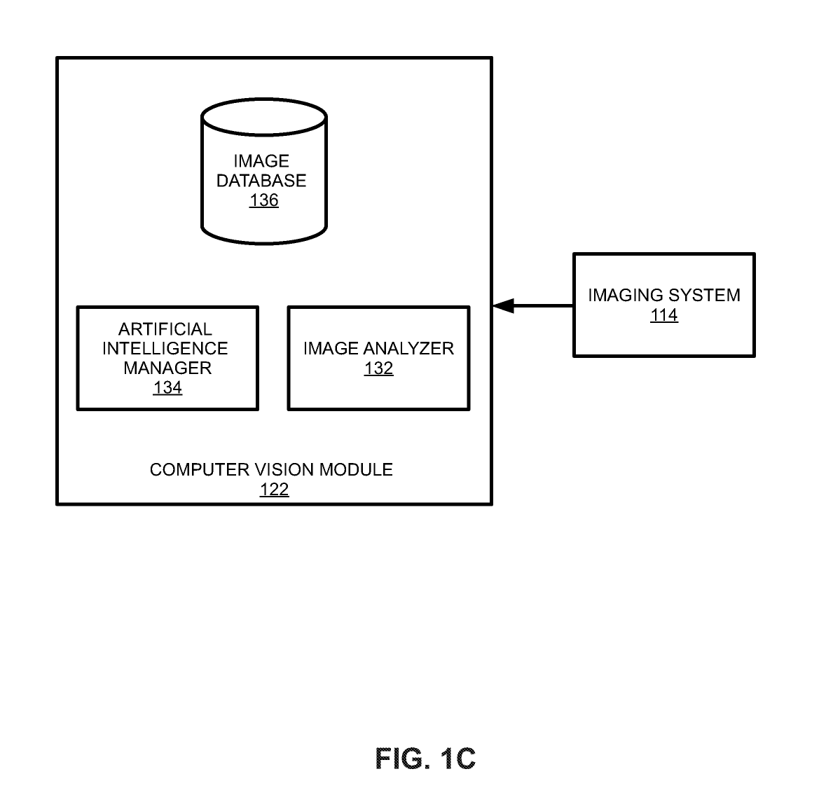

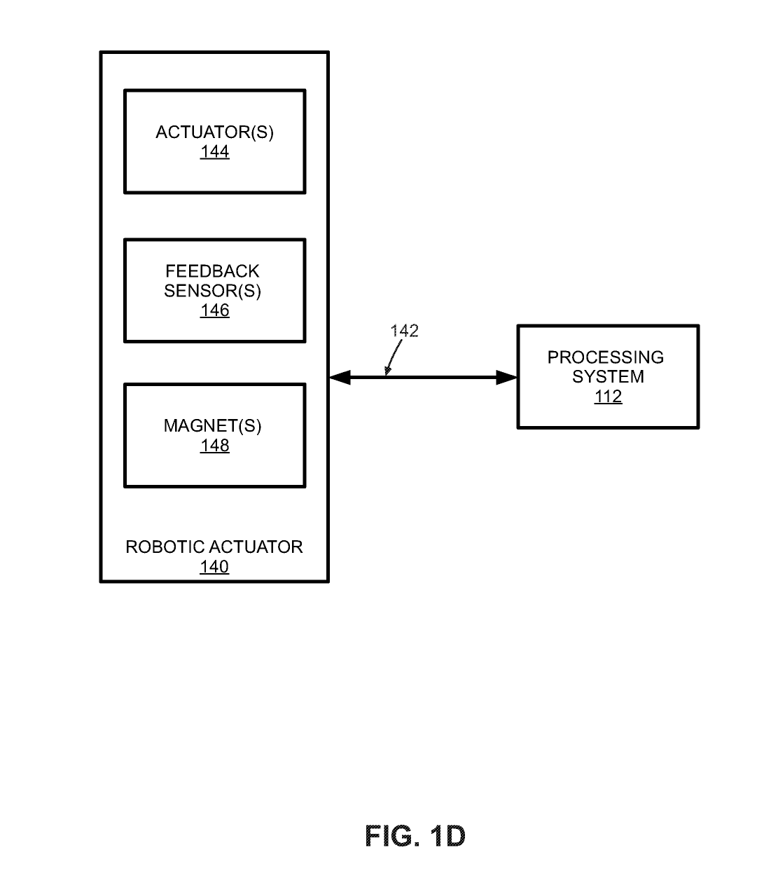

FIG. 1A is a schematic depicting an embodiment of a robotic system 100 configured to manipulate magnetic dishware. In some embodiments, robotic system 100 includes a robotic arm 102, coupled to a magnetic end effector 104. In some embodiments, the combination of robotic arm 102 and magnetic end effector 104 is referred to as a robotic actuator 140, where robotic actuator 140 is configured to manipulate one or more articles of dishware. In some embodiments, robotic actuator 140 may be any one of a robotic arm with one or more pivot points, a robotic arm with multiple degrees of freedom, a single-axis robotic arm, or any other robotic system.

In FIG. 1A, robotic actuator 140 is shown to be manipulating an article of magnetic dishware 106. Magnetic dishware such as magnetic dishware 106 can be defined as an article of dishware that has an integrated magnet or ferromagnetic substance within its structure. In some embodiments, the article of dishware used to construct an article of magnetic dishware may be comprised of a material such as ceramic, plastic, or some other suitable material. In some implementations, the ferromagnetic substance within the structure of an article of magnetic dishware may be comprised of stainless steel. Details of the construction of the magnetic dishware are provided herein. In some embodiments, an article of magnetic dishware may be one or more cooking tools or utensils such as knives, spoons, forks and so on that are made of a material that can be attracted to a magnet. In some embodiments, an article of magnetic dishware may include an article of kitchenware that is comprised at least in part of ferromagnetic material. An article of kitchenware may include any types of pots, pans, or any other articles that may be used in a kitchen or similar environment. In other embodiments, a prep bin (e.g., a plastic prep bin) as used in food service may have one or more clips attached, where the one or more clips are comprised of ferromagnetic material. A prep bin configured in this way may be manipulated by robotic actuator 140.

In some embodiments, magnetic end effector 104 may comprise two permanent magnets sliding vertically inside a tube. These two permanent magnets may be driven by a mechanical drive system, where the mechanical drive system serves to move the two permanent magnets within the tube closer to an article of magnetic dishware to grip and lift the article of magnetic dishware. In the event that an article of magnetic dishware is gripped, the mechanical drive system may move the two permanent magnets away from the article of magnetic dishware to release the grip on the article of magnetic dishware. In other embodiments, the two permanent magnets may be replaced by any combination of permanent magnets and electromagnets. In still other embodiments, the mechanical drive system may be replaced by pneumatic, hydraulic, or spring-loaded mechanisms that may be used to provide actuation (gripping) and release actions associated with an article of magnetic dishware. An embodiment including a magnetic end effector that uses a single magnet sliding vertically inside a tube is described herein.

Robotic arm 102 as depicted in FIG. 1A is a multi-axis robotic arm. In other embodiments, robotic arm 102 may be replaced by a gantry-type Cartesian robot, a Selective Compliance Articulated Robot Arm (SCARA) robot, a Delta robot or any other robotic mechanism.

FIG. 1A also depicts another article of magnetic dishware 108 placed in a standard washing rack 110, such as the racks typically associated with a conveyor-type commercial dishwashing machine. In some embodiments, standard washing rack 110 is configured to hold at least one article of dishware, and may include at least one built-in support to support the at least one article of dishware.

A processing system 112 coupled to robotic arm 102 provides any necessary actuation commands to robotic arm 102 and magnetic end effector 104, based on inputs provided to processing system 112 by an imaging system 114. Imaging system 114 uses one or more imaging devices to provide processing system 112 with visual information associated with the operation with robotic actuator 140. In some embodiments, imaging system 114 may include one or more camera systems. In other embodiments, imaging system may include infrared emitters and associated sensors, or any other type of sensing device. The visual information provided to processing system 112 by imaging system 114 may include still images, video data, infrared images, and so on.

In some embodiments image processing software running on processing system 112 processes the visual information from imaging system 114 to generate the appropriate actuation commands to robotic actuator 140. Visual information from imaging system 114 may also be used by processing system 112 to identify an article of magnetic dishware when the article of magnetic dishware has been picked up by robotic actuator 140.

During operation, processing system 112, based on processing visual information from imaging system 114, issues actuation commands to robotic arm 102. When commanded to pick up a targeted article of magnetic dishware, robotic arm 102 is configured to move in the direction of the targeted article of magnetic dishware based on actuation commands received from processing system 112. When processing system 112 determines that normally deactivated magnetic end effector 104 is approximately within a certain zone associated with the targeted article of magnetic dishware, processing system 112 activates magnetic end effector 104, so that the targeted article of magnetic dishware is attracted to and is gripped by magnetic end effector 104. This process is referred to as engaging the article of magnetic dishware. In some embodiments, the certain zone associated with gripping an article of magnetic dishware by magnetic end effector 104 depends on the strength of the magnet. In particular embodiments, the certain zone associated with gripping an article of magnetic dishware by magnetic end effector 104 is approximately 1 cm.

Processing system 112 then actuates robotic arm 102 to move in the direction of a location where the targeted article of magnetic dishware is to be placed, such as washing rack 110 or a conveyor belt (not shown). In some embodiments, processing system 112 may actuate robotic arm 102 to position magnetic end effector 104 at a point in three-dimensional space, where the positioning process may be aided by visual information provided by imaging system 114 (i.e., move the magnetic end effector 104 within view of at least one camera associated with imaging system 114). When processing system 112 determines that the targeted article of magnetic dishware has reached the desired destination, processing system 112 issues a command to deactivate magnetic end effector 104, so that the targeted article of magnetic dishware is released at the desired destination.

Because the holding force between magnetic end effector 104 and, for example, article of magnetic dishware 106 is more predictable than the grasping forces a mechanical gripper can achieve, the speeds of movement in the described system can be greater, while the chance of dropping an article of dishware is less.

Judicious placement of the magnetic zones in an article of magnetic dishware can reduce inertial loads (such as excessive torsion resulting due to large moment arms), giving a further speed advantage to the magnetic system over a system that employs a mechanical gripper. Placing a magnetic zone (i.e., one or more magnetic elements) in the center (i.e., substantially at the center of gravity) of an article of magnetic dishware (also referred to as a dish) for example, minimizes the moment of inertia of the dish and allows the magnetic end effector to grasp the dish in a way that would be impossible for a robotic hand or mechanical grasping device. This approach serves to reduce the torque that the magnetic end effector will have to exert to lift the article of magnetic dishware. In contrast, a mechanical gripper lifting an article of dishware at a point away from the center of gravity of the article of dishware would have to cope with torsional forces due to the moment arm associated with the distance between the grasp point and the center of gravity of the article of dishware.

Furthermore, the predictability of the magnetic grasp to always pick up a dish in a known pose, allows the movement trajectory of the robotic arm to be optimized for speed and minimal breakage more completely than mechanical grippers. These optimizations are much harder to achieve in mechanical grippers because mechanical grippers generally have more uncertainty in the security of their grasp.

In some embodiments, well-known path planning algorithms can be implemented on processing system 112 to allow the path of a gripped piece of magnetic dishware to follow a desired trajectory. This approach is also applicable to robotic arms with multiple pivot points. Obstacle avoidance can also be included in the processing software, where a robotic arm in motion can use feedback sensors to detect the presence of an obstacle along the path of motion and halt operations until the obstacle is removed and the system reset.

The fact that the positions of the magnetic zones on a dish are known to robotic system 100, along with the self-aligning nature of the magnetic end effector, greatly reduce the requirements on any computer vision system that may be associated with robotic system 100 that is configured to identify a target dish. Locating the appropriate grasp points required by a physical manipulator, such as a hand, often requires accuracy at the millimeter level and this poses a problem for vision systems in dishwashing, as dishes often have food or liquid on them, making it difficult for a computer vision system to properly find surfaces and edges. The systems and methods described herein need only identify a rough outline of a plate or other dish, and then roughly position magnetic end effector 104 in the general area of a magnetic zone for that plate or dish. As the magnet of magnetic end effector 104 is actuated, the dish will self-align to magnetic end effector 104 due to the magnetic attraction between the dish (such as magnetic dishware 106) and magnetic end effector 104.

Cups, plates, bowls, mugs and any other piece of dishware can be made to have magnetic zones either by using magnets or by using a ferromagnetic material such as steel integrated into their structure. This dishware can either be retrofitted with “magnetic pucks” that attach to the dishware, or can be manufactured with magnetic materials embedded inside the dishware material (e.g., ceramic material) directly, as discussed herein.

FIG. 1B depicts an embodiment of processing system 112 that may be used to implement certain functions of robotic system 100 configured to manipulate magnetic dishware. In some embodiments, processing system 112 includes a communication manager 116, where communication manager 116 manages communication protocols and associated communication with external peripheral devices as well as communication within other components in processing system 112. For example, communication manager 116 may be responsible for generating and maintaining the interface between processing system 112 and imaging system 114. Communication manager 116 may also be responsible for managing communication between the different components within processing system 112.

Processing system 112 also includes a processor 118 configured to perform functions that may include generalized processing functions, arithmetic functions, and so on. Data storage for both long-term data and short-term data may be accomplished by a memory 120. A computer vision module 122 may be configured to process visual information received from imaging system 114 via, for example, communication manager 116. In some embodiments, computer vision module 122 determines the approximate location of an article of magnetic dishware that is to be gripped, or the approximate location of where an article of magnetic dishware is to be released. Computer vision module 122 may implement standard image recognition and image processing algorithms. Additional details of computer vision module 122 are provided herein.

Commands for robotic actuator 140 may be generated by a robotic actuator controller 124 configured to generate commands that may cause motion in robotic arm 102, or commands that activate or deactivate magnetic end effector 104. A feedback sensor 126 processes feedback from sensors associated with robotic actuator 140, such as load cells or any similar displacement measurement sensors configured to measure linear or angular displacements. In some embodiments, a load cell is defined as a transducer that is used to create an electrical signal whose magnitude is substantially directly proportional to a force being measured. In some embodiments, a displacement measurement sensor is defined as a transducer that is used to create an electrical signal whose magnitude is dependent on a displacement being measured. Measured displacements could include linear or angular displacements. One or more load cells associated with feedback sensor 126 may provide outputs that measure how much force is being exerted on robotic actuator 140. Outputs from one or more displacement measurement sensors associated with feedback sensor 126 may be used by processor 118 to determine, for example, any additional displacement (linear or angular) that may need to be generated in robotic actuator 140.

In some embodiments, processing system 112 may also include a user interface 128, where user interface 128 may be configured to receive commands from a user, or display information to the user. Commands received from a user may be basic on/off commands, and may include variable operational speeds, for example. Information displayed to a user by user interface 128 may include system health information and diagnostics. User interface 128 may include interfaces to one or more switches or push buttons, and may also include interfaces to touch-sensitive display screens. Data flow within processing system 112 may be routed via a central data bus 129.

FIG. 1C is a block diagram depicting an embodiment of imaging system 114 coupled to computer vision module 122. In some embodiments, imaging system 114 and computer vision module 122 communicate via communication manager 116 (FIG. 1B). Computer vision module 122 receives visual information associated with, for example, an article of magnetic dishware from imaging system 114. Computer vision module 122 processes this visual information to determine, for example, the position of the article of magnetic dishware relative to a magnetic end effector such as magnetic end effector 104.

In some embodiments, computer vision module 122 includes an image analyzer 132 that performs algorithmic analysis on visual information received from imaging system 114. An artificial intelligence manager 134 included in computer vision module 122 may implement artificial intelligence image recognition or similar algorithms. An image database 136 included in computer vision module 122 may store reference images that are accessed by image analyzer 132 or artificial intelligence manager 134. Together image analyzer 132 and artificial intelligence manager 134 use the reference images in image database 136 to perform image recognition on the visual information received from imaging system 114. In some embodiments, standard image processing algorithms are used to implement the functionality of computer vision module 122. In other embodiments, the functionality of computer vision module 122 may be implemented using customized image processing algorithms.

FIG. 1D is a block diagram depicting robotic actuator 140 and processing system 112. In some embodiments, robotic actuator 140 includes robotic arm 102 and magnetic end effector 104. Robotic actuator 140 is coupled to processing system 112 via a bidirectional communications link 142. In some embodiments, robotic actuator 140 may be coupled to communication manager 116 via bidirectional communications link 142.

Processing system 112 issues commands to robotic actuator 140 and receives data from robotic actuator 140 via bidirectional communications link 142. In some embodiments, robotic actuator 140 includes actuators 144, such as servomotors, dc motors and so on. Actuators 144 may be controlled by commands from processing system 112 that are generated in response to results from image processing operations as provided by computer vision module 122. Commands to actuators 144 may include initiating motion, maintaining motion or stopping motion.

In some embodiments, robotic actuator 140 also includes feedback sensors 146, where feedback sensors 146 provide sensor data to processing system 112 via bidirectional communications link 142. Feedback sensors 146 may include load sensors, position sensors, angular sensors, and so on. In some embodiments, load sensors (or load cells) are configured to generate electrical signals that are substantially proportional to an applied force. Load sensors are used to measure forces that may be encountered, for example, by robotic arm 102. In some embodiments, position sensors and angular sensors are configured to measure linear displacements and angular displacements respectively, of robotic arm 102 or magnetic end effector 104. These linear displacement and angular displacement measurements provide an indication of the position of robotic arm 102 or magnetic end effector 104 in three-dimensional space. Data from feedback sensors 146 may be used by processing system 112 to implement, for example, closed-loop control algorithms for positioning robotic actuator 140 in three-dimensional space.

Robotic actuator 140 also includes magnets 148 associated with magnetic end effector 104. Processing system 112 issues commands to activate or deactivate magnets 148 via bidirectional communications link 142. In this way, robotic actuator 140 may be commanded to grip and lift an article of magnetic dishware from a designated location or release it at a designated location.

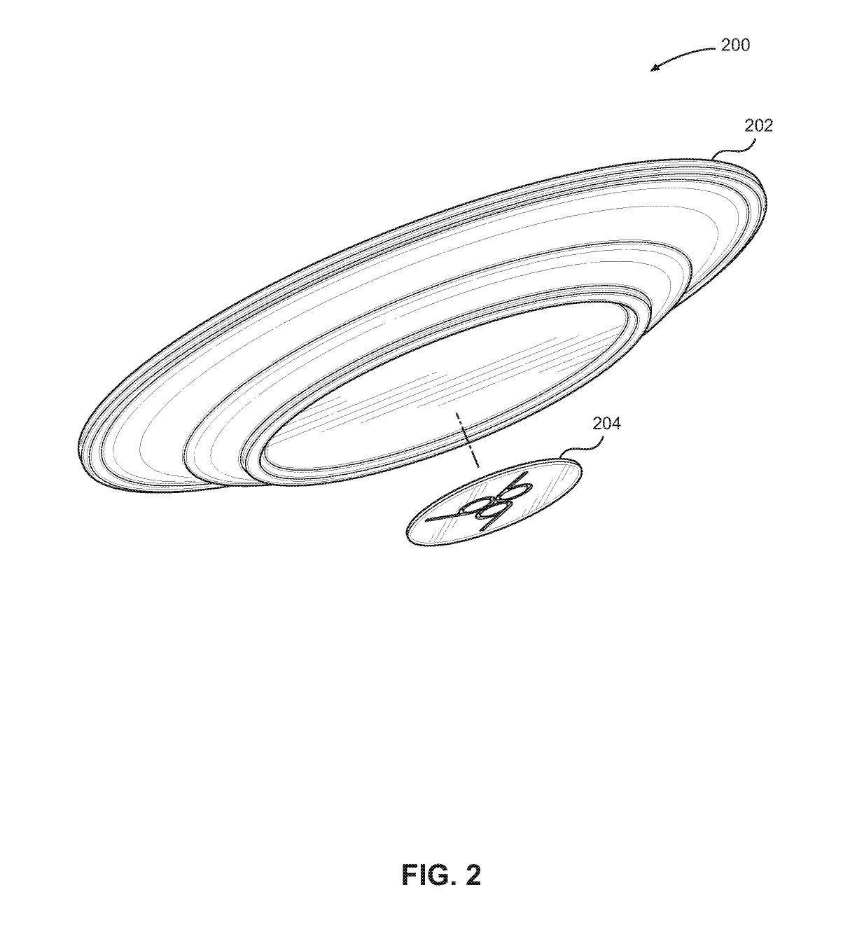

FIG. 2 is a schematic diagram depicting an embodiment of an article of magnetic dishware 200. In some embodiments, a disk 204 comprised of ferromagnetic material is affixed to the bottom of a plate 202. In some embodiments, disk 204 may be encapsulated in a thin plastic covering to prevent rusting, and disk 204 is affixed to the bottom of plate 202 using adhesive. In some embodiments, the exposed surface of disk 204 may be decorated with logos or graphics. While article of magnetic dishware 200 is plate 202, this concept can be applied to other articles of dishware such as bowls, saucers, cups, and so on. Cooking tools (for example, knives, forks or spoons) comprised of materials that are attracted to a magnet can also be manipulated and sorted as discussed herein.

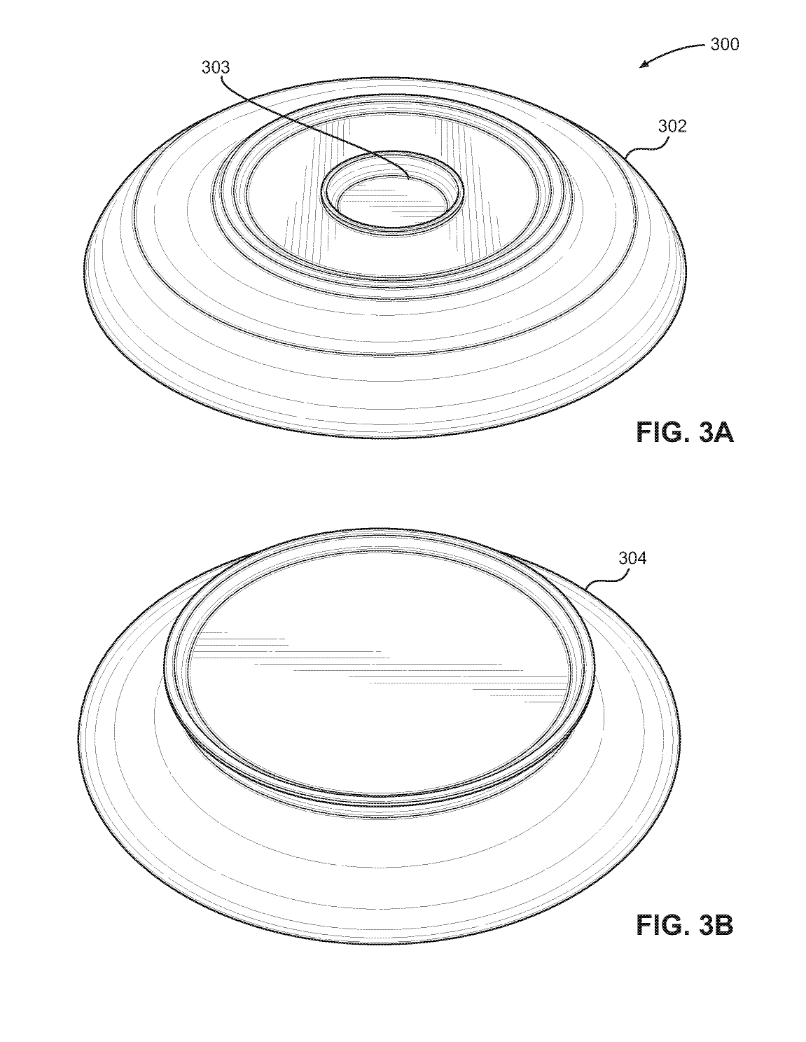

FIG. 3A is a schematic diagram depicting an example article of magnetic dishware 300. The view shows a ceramic plate 302 with a pocket 303 for holding a circular piece of thin steel (e.g., a circular steel plate). In other embodiments, plate 302 can be manufactured from any type of material. Ceramic plate 302 is an unfinished article of magnetic dishware. In some embodiments, the circular steel plate can be embedded into ceramic plate 302 during the manufacturing process. For example, the manufacturing process may include steps such as sealing pocket 303 with the embedded circular steel plate and firing ceramic plate 302 to get a finished ceramic plate.

FIG. 3B is a schematic diagram depicting an example article of magnetic dishware 304. In some embodiments, article of magnetic dishware 304 is a ceramic plate that is the finished product resulting from the manufacturing process discussed with respect to FIG. 3A. Article of magnetic dishware 304 is a finished article of magnetic dishware. In other embodiments, other materials, such as plastic, are used to manufacture the dishware. In some embodiments, dishware with integrated metal zones can be manufactured either via over-molding techniques, or can be manufactured using individual parts and post assembled with either high temperature adhesive in the case of ceramics, or lower temperature adhesive in the case of plastic materials. In particular embodiments, the over-molding process includes, for example, a plastic piece of dishware with a cavity, referred to as a mold cavity. A ferromagnetic metal insert is placed in the cavity, and the cavity is closed by injecting plastic into the cavity such the plastic flows around the metal insert and encapsulates it while filling up the cavity. In other embodiments, a piece of ferromagnetic material (e.g., a ferromagnetic sheet) may be inserted into, for example, a plastic piece of dishware. This process is referred to as insert molding.

Although FIG. 2 and FIG. 3B show a single metal disk placed in the center of a plate, alternate embodiments may include multiple embedded magnetic zones to increase the number of attachment points available to the end effector, or to minimize the torque requirements of a particular geometry.

In some embodiments, article of magnetic dishware 304 can be combined with data-holding objects such as radio frequency identification (RFID tags) or optical encoding schemes such as quick response (QR) codes, bar codes, and so on, to allow an entity or user to inventory or track their dishware, or add other intelligence to the dishware itself. In the case of RFID, the flat antenna can be attached to the metal disk prior to assembly, thus protecting the antenna from the environment. Optical encoding schemes such as invisible patterns can be encoded into the surface of such dishware, assisting the vision system in positioning the magnetic end effector with greater accuracy.

In some embodiments, the data-holding objects may store a unique identification code (ID) for a specific article of magnetic dishware. In particular embodiments, a specific ID may be associated with data pertaining to the article of magnetic dishware that may be stored in a database. In some embodiments, the data-holding objects may be read-only. In other embodiments, the data-holding objects may have read/write capabilities.

Some embodiments may use optical encoding schemes that use optical patterns to assist computer vision operations such as object recognition or pattern recognition as implemented by, for example, computer vision module 122. In particular embodiments, optical encoding schemes may include fiducial marks such as crosses, circles, or other graphics that allow a computer vision system such as computer vision module 122 to better locate pick points.

In some embodiments, an article of magnetic dishware, such as dinner plate 202, may have a plurality of affixed or embedded magnetic elements, or any combination thereof. The advantage of using multiple magnetic elements is that it reduces the accuracy requirements on the robotic system, especially any associated computer vision system and actuator positioning system as described herein. In other embodiments, a magnetic element may be comprised of a ferromagnetic material such as steel.

While FIG. 3A and FIG. 3B depict an article of magnetic dishware that is constructed using custom-fabrication techniques with ferromagnetic plates or discs embedded into the dishware. Additionally, existing dishware can be retrofitted by attaching a magnetic element to the dishware, for example as illustrated in FIG. 2.

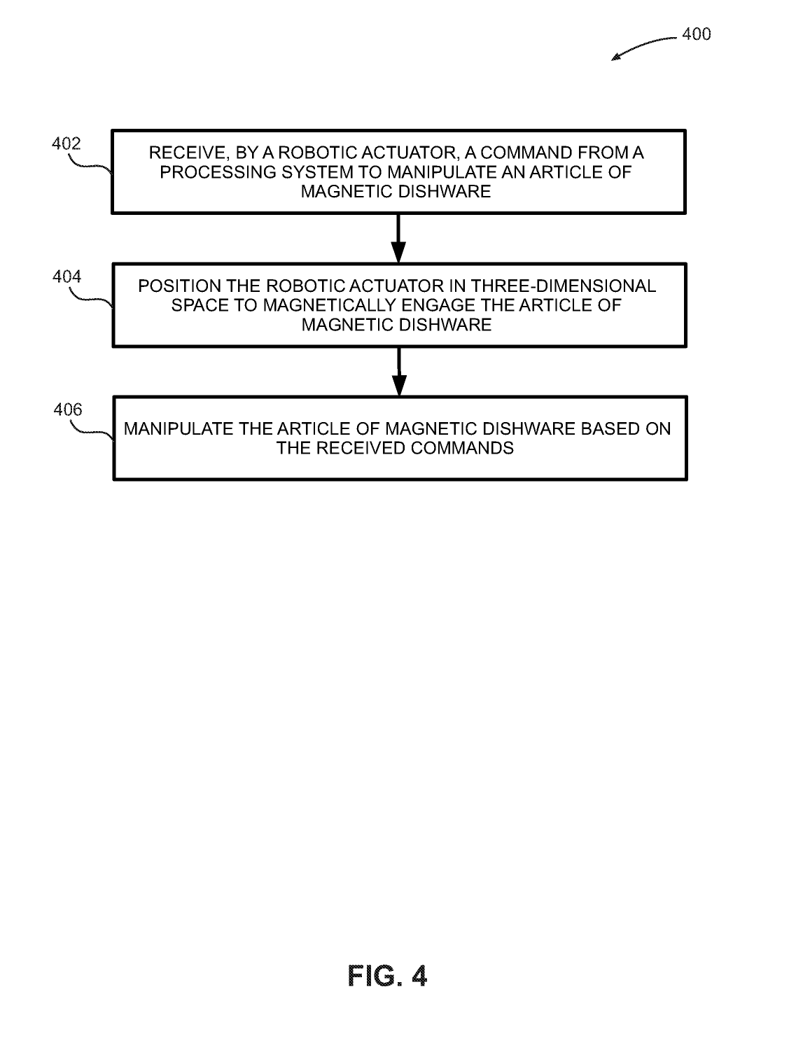

FIG. 4 is a flow diagram depicting an embodiment of a method 400 to manipulate an article of magnetic dishware by a robotic system (e.g., robotic system 100), where the robotic system may include components such as robotic arm 102, magnetic end effector 104, processing system 112, and imaging system 114. At 402, a robotic actuator such as robotic actuator 140 receives a command from a processing system to manipulate an article of magnetic dishware. This command may be generated, for example, by processing system 112 and communicated to robotic actuator 140. An initial command may be generated by processing system 112 when a user switches on the system. At 404, the robotic system positions the robotic actuator in three-dimensional space to magnetically engage the article of magnetic dishware. In some embodiments, processing system 112 may use inputs from imaging system 114 to help position the robotic actuator in an advantageous position to grip and pick up (i.e., engage) the article of magnetic dishware. At 406, the robotic system manipulates the article of magnetic dishware based on the received commands. For example, the received command from processing system 112 might be to move the gripped (engaged) article of magnetic dishware from a first position to a second position. Using inputs from the vision system 114 and predetermined trajectories programmed into processing system 112, processing system 112 can issue commands to move the engaged article of magnetic dishware to, for example, a dishwashing rack or a conveyor belt, where the article of magnetic dishware is deposited or placed.

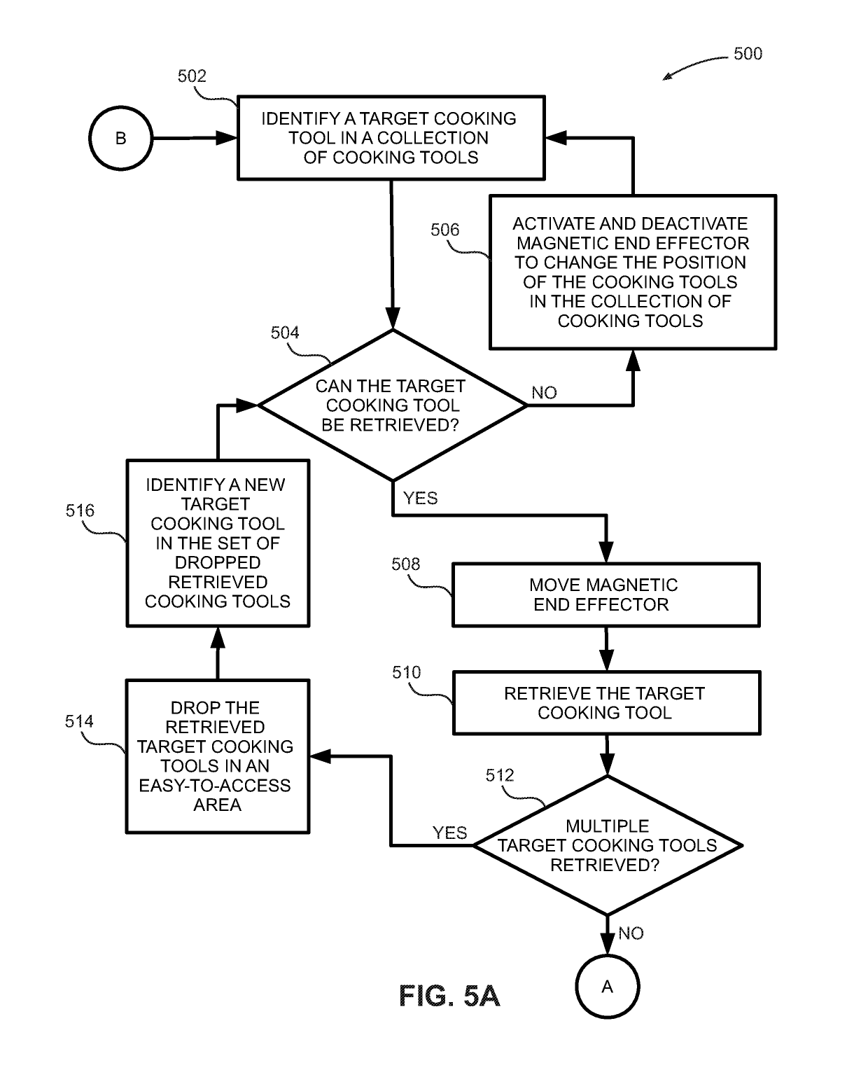

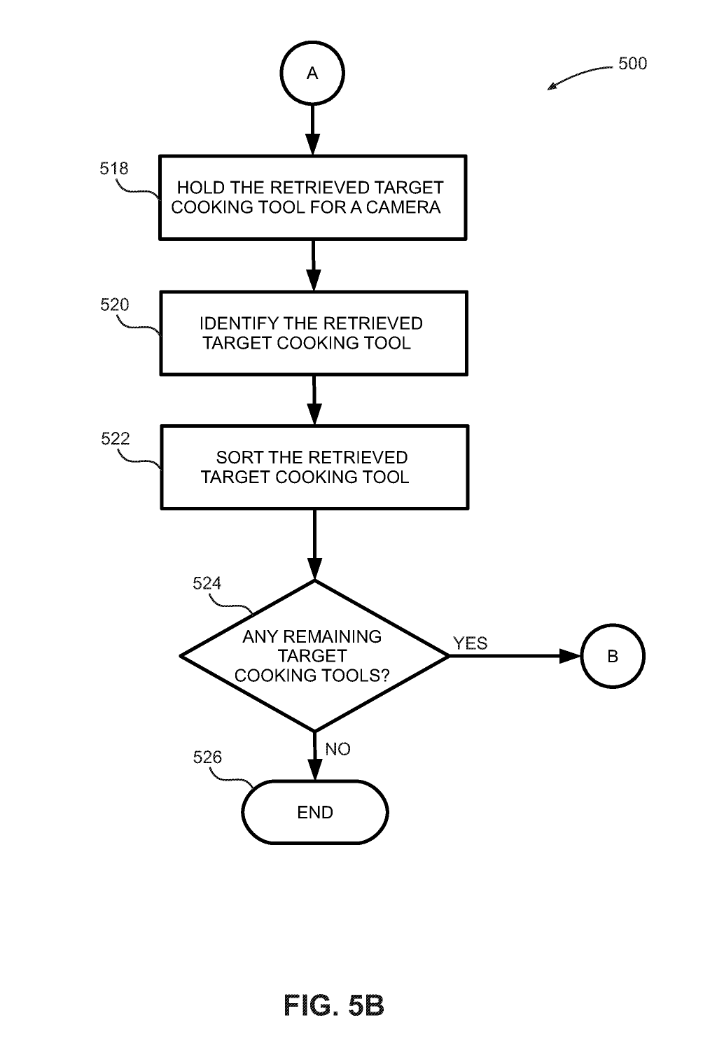

FIG. 5A is a flow diagram depicting an embodiment of a method 500 to sort cooking tools using, for example, robotic system 100, which may include components such as robotic arm 102, magnetic end effector 104, processing system 112, and imaging system 114. “Cooking tools” include any tools for cooking and dining such as knives, forks and spoons, or any other utensils or cooking items.

In commercial dishwashing, unsorted cooking tools may be placed in a flat-bottomed rack or other rack system, and sprayed down to clean away the bulk of the remaining food. After spraying, the cooking tools are either passed through the dishwashing machine and sorted after sanitizing, or the cooking tools are sorted into appropriate containers prior to sanitizing and then passed through the dishwashing machine. In both cases, sorting of the cooking tools is a time-consuming, manual process. As discussed herein “cooking tools” are manufactured using a material that can be attracted to a magnet. By this definition, cooking tools can be classified as articles of magnetic dishware.

Cooking tools can be manipulated by a magnetic end effector such as magnetic end effector 104, in a method that decreases the complexity of the computer vision effort that would be required to solve a mixed-bin problem if it were using a mechanical gripper.

At 502, robotic system 100 identifies a target cooking tool in a collection of multiple cooking tools. The target cooking tool is a specific cooking tool that the robotic system wants to pick up. In some embodiments, the robotic system may use imaging system 114 to identify the target cooking tool. The problem associated with this identification process is often referred to as a mixed-bin picking problem. Mixed-bin picking poses challenges to computer vision systems because the jumbled nature of the objects in the mixed bin makes object features difficult to identify a particular object. Because objects at the bottom of the bin are often occluded by objects at the top of the bin, guiding a physical manipulator to features that enable it to achieve a solid grasp is challenging.

At 504, the robotic system checks to determine whether the target cooking tool can be retrieved. Since the robotic system only needs limited information about the cooking tool being selected in order to make a reliable grasp, and it only needs to be in close proximity to the target object in order to make a grasp attempt due to the advantages offered by the magnetic attraction approach, the decision regarding whether the object can be retrieved at 504 is less demanding for the computer vision system. If, at 504, the robotic system determines that the target cooking tool cannot be retrieved then the method proceeds to 506, where processing system 112 may activate and deactivate magnetic end effector 104 to change the position of the cooking tools in the collection of cooking tools, after which the method returns to 502. In other words, at 506, the robotic system activates and deactivates magnetic end effector 104 to effectively stir the cooking tools to change the pose and position of these objects.

If, at 504, the robotic system determines that the target cooking tool can be retrieved then the method continues to 508, where the robotic system moves magnetic end effector 104 towards the target cooking tool. At 510, the robotic system retrieves the target cooking tool by activating magnetic end effector 104 and gripping the target cooking tool using magnetic attraction. At 512, the robotic system checks to see whether multiple (i.e., more than one) target cooking tools have been retrieved. In some embodiments, magnetic end effector 104 may grip and retrieve more than one target cooking tools at step 510 due to the properties of magnetic attraction. If, at 512, the method determines that multiple target cooking tools have been retrieved then the method goes to 514, where the retrieved target cooking tools are dropped in an easy-to-access area. In some embodiments, the target cooking tools are dropped (or placed) in the easy-to-access area by deactivating magnetic end effector 104. Next, at 516, the robotic system identifies a new target cooking tool in the set of dropped retrieved cooking tools (a step similar to 502), and the method returns to 504.

If, at 512, the robotic system determines that multiple (i.e., more than one) target cooking tools have not been retrieved (implying that a single target cooking tool has been retrieved) then the method continues to A, with a continued description in FIG. 5B.

FIG. 5B is a continued description of the method 500. Starting at A, the method continues to 518, where the robotic system holds the retrieved target cooking tool for a camera, where the camera may be a part of imaging system 114. At 520, computer vision module 122 identifies the retrieved target cooking tool. This identification process is also significantly easier for computer vision module 122, because it can be done post-object retrieval on a single object. Furthermore, the robotic actuator can move the objects to different positions, or even hold it against different backgrounds to improve the information available to imaging system 114 and computer vision module 122. Next, at 522, the retrieved target cooking tool is sorted. For example, the retrieved target cooking tool may be sorted according to its type (e.g., a spoon, a fork or a knife).

At 524, the robotic system checks to determine whether there are any remaining target cooking tools. If there are any remaining target cooking tools then the method continues to B, and returns to 502, where the process is repeated. If, at 524, the robotic system determines that there are no remaining target cooking tools then the process ends at 526. In some embodiments, method 500 can be applied to articles of magnetic dishware other than cooking tools.

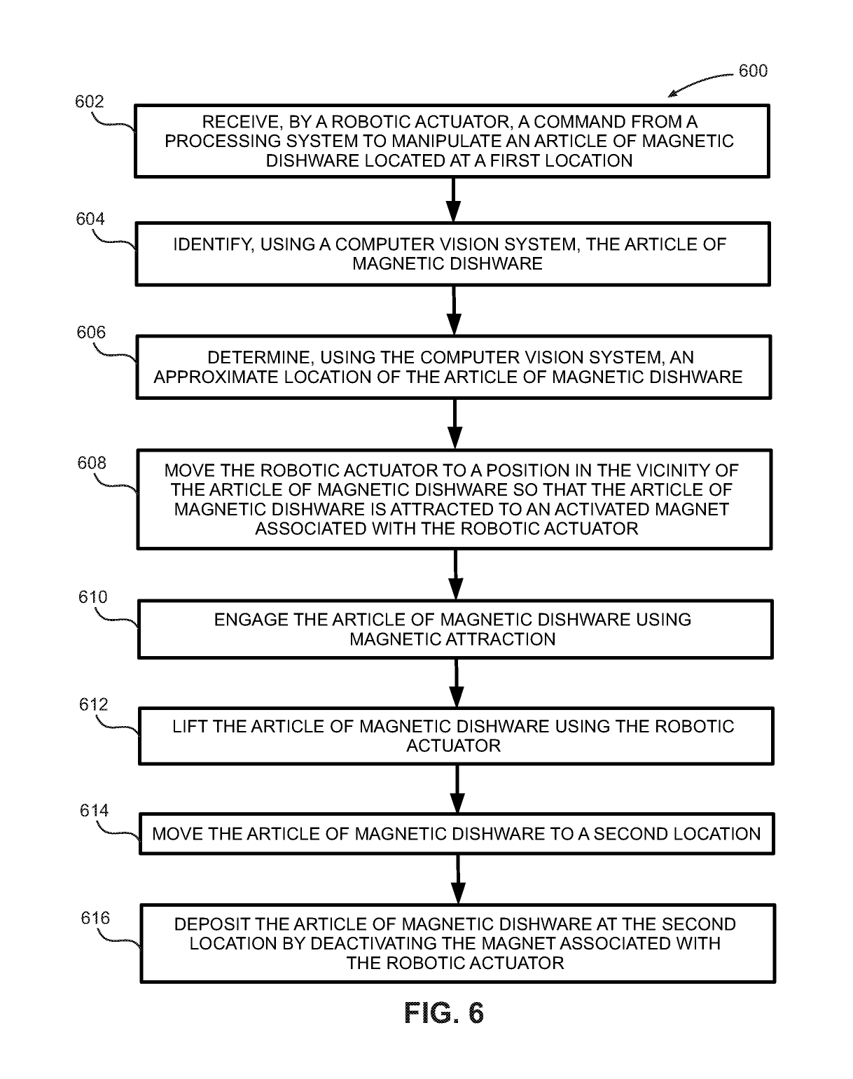

FIG. 6 is a flow diagram depicting an embodiment of a method 600 to manipulate an article of magnetic dishware by a robotic system (e.g., robotic system 100), where the robotic system may include components such as robotic arm 102, magnetic end effector 104, processing system 112, and imaging system 114. At 602, a robotic actuator (such as a combination of robotic arm 102 and magnetic end effector 104) receives a command from a processing system (such as processing system 112) to manipulate an article of magnetic dishware (such as magnetic dishware 106) located at a first location. The robotic system might be initialized by a user of the system via, for example, a switch or a button, where the user loads the magnetic dishware at a designated location and switches the system on.

At 604, the robotic system identifies the article of magnetic dishware using a computer vision system (such as a combination of imaging system 114 and computer vision module 122). At 606, the robotic system uses the computer vision system to determine an approximate location of the article of magnetic dishware. In some embodiments, the locating process for the computer vision system may be aided by fiducials, markings or patterns on the article of magnetic dishware.

At 608, the robotic system moves the robotic actuator to a position in the vicinity of the article of magnetic dishware so that the article of magnetic dishware is attracted to an activated magnet associated with the robotic actuator. In some embodiments, the activated magnet is associated with magnetic end effector 104, when magnetic end effector 104 has received an activation command from processing system 112. In particular embodiments, the robotic actuator may first be moved towards the article of magnetic dishware with magnetic end effector 104 deactivated, where magnetic end effector 104 is activated once processing system 112 determines that magnetic end effector 104 is sufficiently close to the article of magnetic dishware. In some embodiments, magnetic end effector 104 has a permanent magnet that attracts and engages the article of magnetic dishware when robotic arm 102 moves magnetic end effector 104 close enough to the article of magnetic dishware. This self-aligning feature that is a characteristic of magnetic systems reduces the dependence on a high-accuracy computer vision system. In other words, the approach using magnetic dishware and an associated magnetic robotic actuator is able to tolerate a certain degree of misalignment between magnetic end effector 104 and an article of magnetic dishware. Processing system 112 can also be programmed so that the trajectories of motion of the robotic actuator can be programmed to move in the direction of increasing magnetization to establish and maintain a firmer grasp on the object being moved.

At 610, the robotic system engages the article of magnetic dishware using magnetic attraction, where the process of engaging the article of magnetic dishware involves gripping the article of magnetic dishware using magnetic attraction so that the article of magnetic dishware can be lifted and moved to an appropriate destination. At 612, the robotic system lifts the article of magnetic dishware using the robotic actuator. At 614, the robotic system moves the article of magnetic dishware to a second location. At 616, the robotic system deposits the article of magnetic dishware at the second location by deactivating the magnet associated with the robotic actuator. In some embodiments, the magnetic associated with the robotic actuator is the magnetic associated with magnetic end effector 104, and the deactivation process for the magnet may include, for example, switching off the electric current to an electromagnet associated with magnetic end effector 104, or physically moving a permanent magnet associated with magnetic end effector 104 as described earlier in this specification.

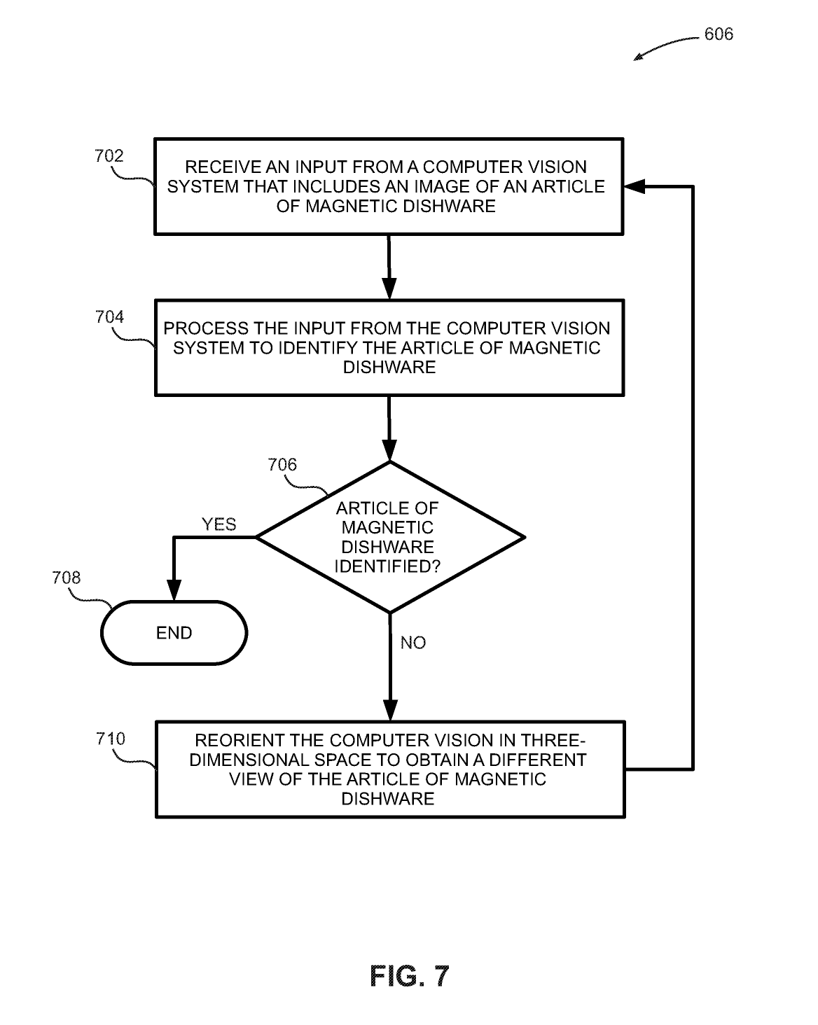

FIG. 7 is a flow diagram depicting an embodiment of a method 606 that uses a computer vision system to identify an approximate location of an article of dishware. This flow diagram expands the discussion of step 606 associated with method 600. At 702, the robotic system from method 600 receives an input from a computer vision system that includes an image of an article of magnetic dishware. In some embodiments, the computer vision system may include a combination of imaging system 114 and computer vision module 122. Next, at 704, the robotic system processes the input from the computer vision system to identify the article of magnetic dishware. In some embodiments, imaging system 114 provides the image of the article of magnetic dishware as visual information, while computer vision module 122 performs the task of processing the visual information to identify the article of magnetic dishware. Next, at 706, the robotic system determines whether the article of magnetic dishware is identified. If not, then the method proceeds to 710, where the computer vision system is reoriented in three-dimensions to obtain a different view of the article of magnetic dishware. In some embodiments, imaging system 114 is reoriented in three-dimensions to obtain a different view of the article of magnetic dishware. The method then returns back to 702, where the process repeats. If, at 706, the robotic system determines that the article of magnetic dishware is identified, then the method continues to 708, where the process ends and continues to step 608 associated with method 600.

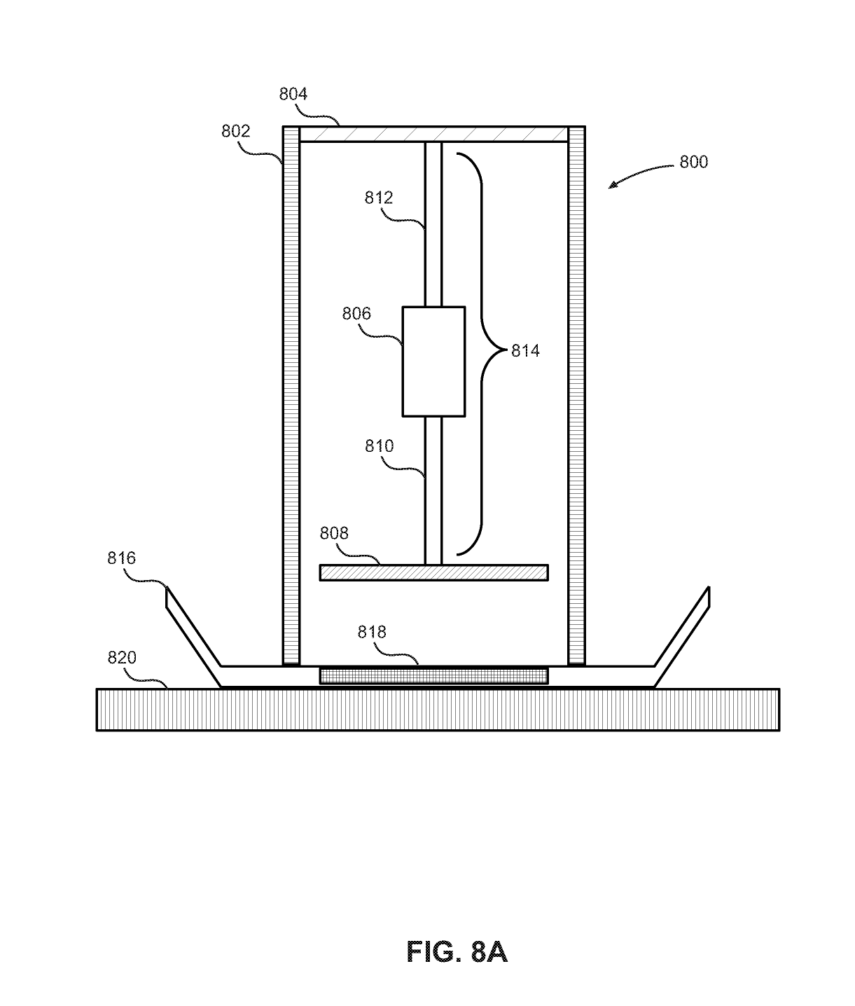

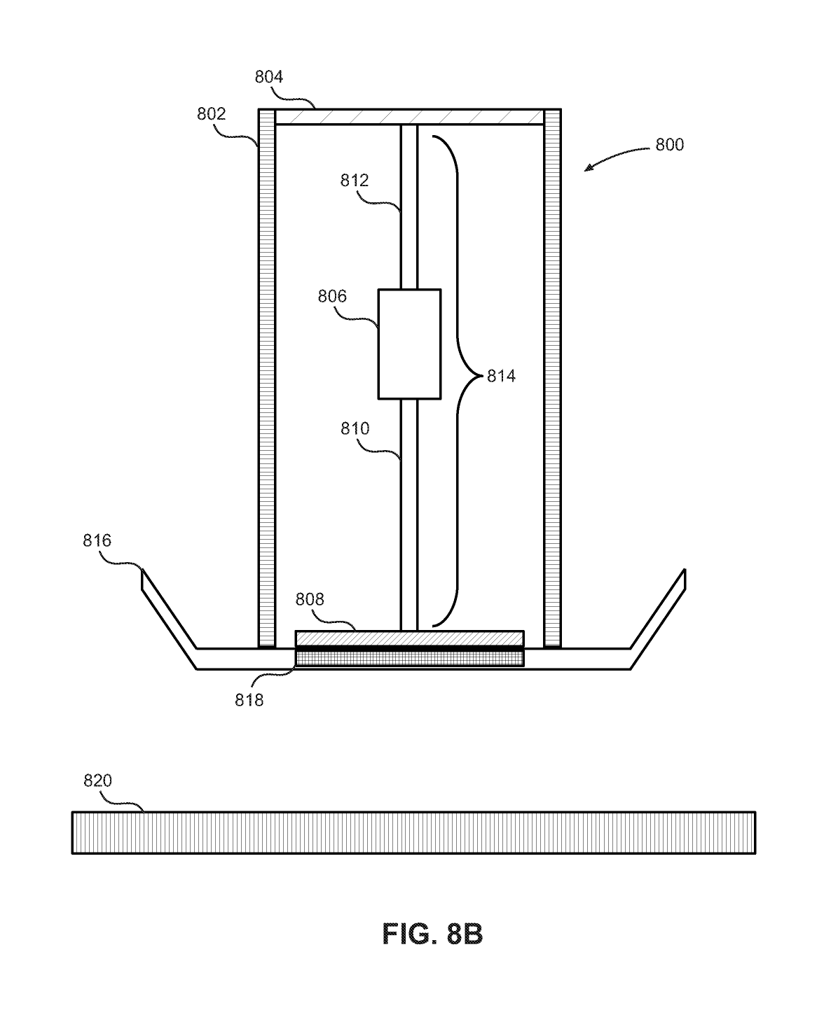

FIG. 8A is a schematic diagram depicting an embodiment of a magnetic end effector 800. In some embodiments, magnetic end effector 800 includes a tube 802. In some embodiments, tube 802 may be of a circular cross section. In other embodiments, tube 802 may be of a square or rectangular cross section. In still other embodiments, the cross section of tube 802 may be a shape corresponding to any arbitrary polygon.

In some embodiments, magnetic end effector 800 may include a mechanical actuator 814 comprised of a rigid support 804, a rigid beam 812, an actuator motor 806, and a drive shaft 810. A magnet 808 is rigidly attached to drive shaft 810 so that magnet 808 is completely contained within tube 802 for certain positions of drive shaft 810 as commanded by actuator motor 806. In particular embodiments, rigid support 804 is rigidly attached to tube 802. In some embodiments, tube 802 or rigid support 804 may be attached to robotic arm 102, in which case rigid support 804 provides a substantially rigid foundation for mechanical actuator 814 and magnetic end effector 800.

In some embodiments, magnet 808 may be a permanent magnet. In other embodiments, magnet 808 may be an electromagnet. In particular embodiments, mechanical actuator 814 may be physically configured within tube 802 so that rigid beam 812 is rigidly attached to rigid support 804. In some embodiments, rigid beam 812 is mechanically coupled to and physically supports actuator motor 806. Actuator motor 806 is configured to move drive shaft 810 in a direction that is substantially parallel to the axis of tube 802. Upon receiving a command from processing system 112, actuator motor 806 may move drive shaft 810 either towards the open end of tube 802, or away from the open end of tube 802. Since magnet 808 is rigidly attached to drive shaft 810, magnet 808 correspondingly moves either towards or away from the open end of tube 802. In this way, mechanical actuator 814 is configured to move magnet 808 either towards or away from the open end of tube 802 based on commands from processing system 112. In some embodiments, drive shaft 810 may be extended so that magnet 808 is outside tube 802. Or, drive shaft 810 may be withdrawn from the open end of tube 802 so that magnet 808 is fully contained within tube 802. This process is used to implement certain functionalities of magnetic end effector 800 when used for manipulating magnetic dishware as discussed herein.

FIG. 8A also depicts an article of magnetic dishware 816 with an embedded magnetic element 818. Article of magnetic dishware 816 rests on a workbench (or other surface) 820. Tube 802 is shown to be positioned so that its open (distal) end rests on the surface of article of magnetic dishware 816. This position of tube 802 is a starting position in the process of manipulating article of magnetic dishware 816.

FIG. 8B is a schematic diagram depicting an operating mode of magnetic end effector 800. FIG. 8B depicts magnetic end effector 800 comprising tube 802, mechanical actuator 814, and magnet 808. FIG. 8B also depicts article of magnetic dishware 816 that is being gripped by magnetic end effector 800 via magnet 808. To initiate the gripping process, magnetic end effector 800 may be moved towards article of magnetic dishware 816 via robotic arm 102 until the distal end of tube 802 rests on article of magnetic dishware 816 (as shown in FIG. 8A). Then, mechanical actuator 814 may be commanded to extend magnet 808 towards embedded magnetic element 818 by extending drive shaft 810. When magnet 808 is within a certain zone (for example, 1 cm) of magnetic element 818, article of magnetic dishware 816 is attracted to and gripped by magnet 808 via magnetic attraction (magnetic attractive forces) between magnet 808 and magnetic element 818. FIG. 8B depicts article of magnetic dishware 816 being lifted by magnetic end effector 800 above workbench 820. Article of magnetic dishware 816 may now be transported to a desired destination using robotic arm 102.

In some embodiments, if article of magnetic dishware 816 is to be deposited at the desired destination and if magnet 808 is an electromagnet, then electrical power to magnet 808 may be interrupted, such that magnet 808 loses its magnetic properties. The magnetic force coupling article of magnetic dishware 816 to magnet 808 is eliminated, causing article of magnetic dishware 816 to be released and deposited. In other embodiments, if article of magnetic dishware 816 is to be deposited at the desired destination and if magnet 808 is a permanent magnet, then mechanical actuator 814 may by commanded by processing system 112 to activate actuator motor 806 to withdraw (i.e., retract) drive shaft 810 from the open end of tube 802. Due to this action, magnet 808 also gets withdrawn from the open (distal) end of tube 802, moving in a direction towards the interior of tube 802.

In some embodiments, tube 802 is configured such that the cross-sectional area of article of magnetic dishware 816 is greater than the cross-sectional area of tube 802. As magnet 808 is withdrawn within tube 802, the open edge of tube 802 poses a rigid physical constraint to article of magnetic dishware 816. As mechanical actuator 814 continues to withdraw magnet 808 within tube 802, article of magnetic dishware 816 cannot continue moving with magnet 808 due to the physical constraint posed to article of magnetic dishware 816 by tube 802, due to which magnet 808 becomes physically uncoupled from magnetic element 818. Due to this uncoupling, any magnetic forces between magnet 808 and magnetic element 818 that serve to allow magnetic end effector 800 to grip article of magnetic dishware 816 reduce to being less than the weight of article of magnetic dishware 816, causing article of magnetic dishware 816 to be released from the magnetic grip of magnetic end effector 800. This completes the process of depositing article of magnetic dishware 816 at the desired destination.

Although the present disclosure is described in terms of certain example embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. An apparatus comprising:
a robotic actuator including at least one magnet, wherein the robotic actuator is configured to manipulate, using magnetic attraction, an article of magnetic dishware; and
a processing system electrically coupled to the robotic actuator, wherein the processing system is configured to generate commands for positioning the robotic actuator in three-dimensional space.

2. The apparatus of claim 1, wherein the at least one magnet is at least one of an electromagnet and a permanent magnet.

3. The apparatus of claim 1, wherein at least a portion of the article of magnetic dishware includes at least one of a ferromagnetic element and an integrated steel disk.

4. The apparatus of claim 1, wherein at least a portion of the article of magnetic dishware includes an element that is a permanent magnet.

5. The apparatus of claim 1, wherein at least a portion of the article of magnetic dishware includes a plurality of magnetic elements.

6. The apparatus of claim 1, wherein the article of magnetic dishware includes cooking tools.

7. The apparatus of claim 1, wherein at least a portion of the magnetic dishware includes at least one magnetic element, wherein the at least one magnetic element is located substantially at the center of gravity of the magnetic dishware to reduce the torque exerted by the robotic actuator while manipulating the article of magnetic dishware.

8. The apparatus of claim 1, wherein at least a portion of the article of magnetic dishware includes at least one of an RFID data encoding scheme and an optical data encoding scheme, and wherein the optical data encoding scheme comprises at least one of a QR code and a bar code.

9. The apparatus of claim 1, wherein the processing system uses a computer vision system to assist in positioning the robotic actuator in three-dimensional space.

10. The apparatus of claim 1, wherein the processing system uses a computer vision system to identify a specific article of magnetic dishware when the specific article of magnetic dishware has been picked up by the robotic actuator.

11. The apparatus of claim 1, wherein the robotic actuator is at least one of a multi-axis robotic arm, a gantry-type Cartesian robot, a delta robot, and a Selective Compliance Articulated Robot Arm (SCARA) robot.

12. The apparatus of claim 1, wherein a portion of the robotic actuator is comprised of:
a tube;
a mechanical actuator disposed within the tube and rigidly attached to the tube; and
a magnet rigidly attached to a drive shaft associated with the mechanical actuator, wherein the mechanical actuator is configured to position the magnet substantially along an axis associated with the tube, wherein a first position of the magnet is used for engaging an article of magnetic dishware, and wherein a second position of the magnet is used for disengaging an engaged article of magnetic dishware.

13. A method comprising:
receiving, by a robotic actuator, a command from a processing system to manipulate an article of magnetic dishware, wherein the received command provides instructions for positioning the robotic actuator in three-dimensional space, and wherein the robotic actuator includes at least one magnet;
positioning the robotic actuator, based on the received command, to magnetically engage the article of magnetic dishware using the at least one magnet; and
manipulating the article of magnetic dishware based on the received command.

14. The method of claim 13, further comprising stirring, by the robotic actuator, a plurality of articles of magnetic dishware to identify and retrieve a specific article of magnetic dishware.

15. The method of claim 13, further comprising repositioning, by the robotic actuator, an article of magnetic dishware to facilitate identification of the article of magnetic dishware using computer vision.

16. The method of claim 13, wherein positioning the robotic actuator includes determining, using computer vision, the approximate position of an article of magnetic dishware in three-dimensional space.

17. The method of claim 16, further comprising moving the robotic actuator to a position in the vicinity of the article of magnetic dishware, wherein the article of magnetic dishware is attracted to the at least one magnet.

18. The method of claim 17, further comprising using magnetic attraction to self-align the robotic actuator with the article of magnetic dishware.

19. The method of claim 13, wherein manipulating the article of magnetic dishware includes:
lifting, using magnetic attraction, the article of magnetic dishware;
moving the article of magnetic dishware from a first location in three-dimensional space to a second location in three-dimensional space; and
depositing the article of magnetic dishware at the second location in three-dimensional space.

20. The method of claim 13, further comprising configuring the robotic actuator to move in a direction of increasing magnetization associated with the article of magnetic dishware.
